(19) United States
(12) Patent Application Publication
(10) Pub. No.: US 2016/0170118 A1
(43) Pub. Date: Jun. 16, 2016

(54) ACTIVE RETARDATION FILMS BASED ON POLYMER STABILIZED CHOLESTERIC LIQUID CRYSTAL

(71) Applicant: Kent State University, Kent, OH (US)

(72) Inventors: Liang-Chy Chien, Hudson, OH (US); Andrii Varyantsia, Kent, OH (US)

(21) Appl. No.: 14/969,917

(22) Filed: Dec. 15, 2015

Related U.S. Application Data
(60) Provisional application No. 62/091,756, filed on Dec. 15, 2014.

(51) Int. Cl. G02B 5/32; B29D 11/00; G02F 1/1341; G02F 1/1337; G02F 1/1333

(52) U.S. Cl. CPC G02B 5/32; G02F 1/1337; G02F 1/133305; G02F 1/1341; B29D 11/00788; B29K 2105/0079

(57) ABSTRACT

This invention is related to electro-optical devices and active retardation films that can modulate one or more of the amplitude, phase or polarization of an electromagnetic wave. The active retardation film is based on a polymer-stabilized cholesteric liquid crystal (PS-CLC) in a cell with helix lying in the plane parallel to the substrates at zero voltage. An electro-optical cell to observe such electro-optical effect comprises of two substrates with transparent conductive electrodes coated inside the cell and the substrates are coated with alignment layers whereby the alignment layers are treated to provide uniform alignment of the cholesteric helix. Polymerizing a small amount of a reactive monomer in the cholesteric stabilize the ULH texture at zero voltage. The electro-optical effect is achieved by applying a bias field to induce an in-plane rotation of cholesteric helical initially parallel to one of a pair of polarizers crossed at 90 degrees. The retardation value of PS-CLC reaches maximum in response to a bias electric voltage when the rotation of the helix axis is at 45-degree tilt between the crossed polarizers. The active retardation films can be used as single or tandem films. These added features offer many new device applications including beam steering devices, spatial light modulators, displays and other devices.

### CROSS REFERENCE TO RELATED APPLICATION

This application claims priority to and the benefit of U. S. Provisional Patent Application No. 62/091,756 filed on Dec. 15, 2014, and is incorporated herein by reference in its entirety.

### TECHNICAL FIELD

The invention relates to active retardation film that can modulate one or more of the amplitude, phase or polarization of an electromagnetic wave in an optical device.

### BACKGROUND OF THE INVENTION

The flexoelectro-optic effect in liquid crystals has been identified and is usually observed and discussed in association with cholesteric liquid crystals (CLC) with a short pitch. When an electric field is applied normally to the helical axis (HA) of the CLC, the flexoelectric coupling causes a periodic splay-bend deformations and collective reorientation of liquid crystal (LC) molecules which results in a macroscopic rotation of the HA. The flexoelectro-optic effect is sometimes observed in an electro-optic LC cell with a uniform lying helix (ULH) texture of the CLC and the HA parallel to the plane of substrate. A ULH CLC texture behaves optically as a birefringent plate with an effective optical axis along the HA. When an electric field is applied across the cell, the flexoelectric coupling causes an in-plane rotation of the HA which is described by equation (1):

$$ϕ = tan ( \frac{{e}_{f}}{K} \frac{Ep}{2 π} ) \qquad ( 1 )$$

where e_{f}, K−average of splay and bend elastic constants, E is applied voltage and flexoelectric constants:

$${e}_{f} = \frac{{e}_{s} + {e}_{b}}{2} , K = \frac{{K}_{11} + {K}_{33}}{2} ,$$

p−CLC pitch.

The flexoelectro-optic effect is attractive for some device applications due to a characteristic time for rotation of the HA (˜0.01-˜1.0 ms) being much smaller than a typical characteristic time for reorientation of the nematic LC molecules which arise from a dielectric coupling to applied electric field (˜2-˜5 ms).

The flexoelectro-optic performance of the LC device strongly depends on the flexoelectric constant of the LC material. Typically, the LCs designed for commercial liquid crystal displays (LCD) have rather small flexoelectric constants causing high operating voltage or small rotation of the HA in flexoeletro-optic mode. Large flexoelectric coefficients were discovered in LCs with a bimesogenic chemical structure. Typically, the temperature range of the LC phase of bimesogenic LCs (˜100° C.-˜200° C.) is significantly higher than a room temperature (22° C.). Efforts in development of LC mixtures for flexoelectro-optic LC mode were focused on an increase of flexoelectric coefficients in bimesogenic LCs and at the same time on lowering the operating temperature of these materials. However, due an increase of effective viscosity the bimesogeinc CLC mixtures which are able to operate in flexoelectro-optic mode at lower temperatures have demonstrated a significant increase of flexoelectric response time comparing to higher temperatures: from ˜0.1 ms-˜1.0 ms at 80° C.-90° C. to ˜3 ms-˜12 ms at 35° C.-45° C., depending on the CLC pitch.

In view of the foregoing, it would be desirable to develop a CLC mixture for flexoelectro-optic LC mode by using LC constituents with smaller and bigger flexoelectric coefficients and different temperature ranges of LC phases.

### SUMMARY OF THE INVENTION

The invention is directed to active retardation films is based on a polymer-stabilized cholesteric liquid crystal (PS-CLC) in a cell with helical axis lying in the plane parallel to the substrates of the cell at zero voltage. An electro-optical cell to observe such electro-optical effect comprises two substrates with transparent conductive electrodes coated inside the cell. The substrates are coated with alignment layers whereby the alignment layers are treated to provide uniform alignment of the cholesteric helix. The helical axis tilts in-plane from the initial alignment state in response to an applied electric field. The magnitude of tilt depends on applied voltage, frequency of applied voltage and waveform. The invention relates to the CLC mixture for flexoelectro-optic liquid crystal mode and methods to obtain fast and large angle flexoelectric in-plane rotation of the helical axis (HA) in the uniform lying helix (ULH) CLC texture and a flexoelectro-optic LC device operating at a room temperature. In this invention, the liquid crystal (LC) mixture for flexoelecro-optic LC mode is produced from constituents with smaller and bigger flexoelectric coefficients and different temperature ranges of LC phases. A uniform lying helix LC device with a large flexoelastic coefficient, fast flexoelectric switching and operating at a room temperature is provided, resolving the deficiencies of past efforts.

### BRIEF DESCRIPTION OF THE DRAWINGS

FIG. 1 shows the structure of the apparatus for measurement of flexoelectro-optic response.

FIG. 2a shows the distribution of the monomer in the cell prior to polymerization and FIG. 2b shows the polymer network with polymer fibers localized on the surfaces of the substrates of the cell after polymerization.

FIG. 3 shows the process for making the electro-optical device.

FIG. 4a shows the appearance of the ULH under a polarizing optical microscope (POM) and FIG. 4b shows a cell viewed between crossed polarizers on a light box according to an example.

FIG. 5 shows the in plane rotation angle of the HA as a function of applied voltage according to an example.

FIG. 6a shows the static flexoelectro-optic voltage response of the sample in the normally dark configuration, measured at 60 Hz and FIG. 6b shows POM images with corresponding magnitude of applied voltage according to an example.

FIG. 7 shows the waveforms of driving AC voltage and flexoelectro-optic responses of the sample in the normally dark configuration at 4.3 and 21.7 V/μm according to an example.

FIGS. 8a and 8b show the rise and decay pulses from an active retardation films based on PS-CLC according to an example of the invention.

FIG. 9 shows the flexoelectric response time of a sample according to the invention in the normally dark configuration according to an example.

FIG. 10 shows the transmission spectrum of the PS-CLC active retarder according to an example of the invention.

### DETAILED DESCRIPTION OF THE INVENTION

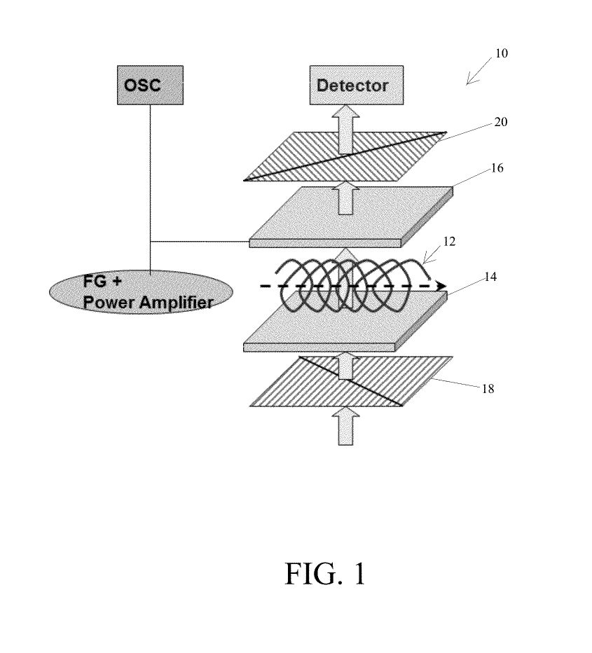

The invention is directed to active retardation films and electro-optical cells using a polymer-stabilized cholesteric liquid crystal (PS-CLC). Referring to FIG. 1, an illustrative first example of the electro-optical structure of the invention will be described. The electro-optical structure 10 generally comprises a uniform lying helix (ULH) LC device with a large flexoelastic coefficient, fast flexoelectric switching and operating at a room temperature. In this example, the device comprises an amount of a nematic liquid crystal (either a positive or negative dielectric anisotropy) and a chiral dopant to form a cholesteric liquid crystal (CLC) 12. The CLC material 12 is interposed between a pair of optically-transparent electrically-conductive layers supported upon a pair of spaced-apart transparent substrates 14 and 16. In this example, the perimeter edges of which are sealed, and across which a voltage is applied under the control of a microcontroller (not shown). As used herein the term “transparent” means that the film does not absorb a significant amount visible radiation and does not reflect a significant amount of visible radiation, rather, it is transparent to visible radiation. A plurality of spacers (not shown) may be included within CLC material 12 to separate and maintain the space between the optically transparent electrically-conductive layers and substrates 14 and 16.

The transparent electrically conductive layers may comprise indium tin oxide (ITO), silver, zinc oxide or other optically transparent conductive polymer or like film coating. Chemical vacuum deposition, chemical vapor deposition, evaporation, sputtering, or other suitable coating techniques may be used for applying the conductive layers to the transparent substrates 14 and 16. In some examples, providing a conductive layer on at least one of the substrates may be sufficient. In an example, thin alignment layers (e.g., polymide ˜20-60 nm) were deposited on top of the substrates. To facilitate alignment of the CLC material, in an example, the substrates were rubbed unidirectionally to create an anisotropy surface with nano-sized grooves to align HA of the CLC material. Electro-optical cells were assembled with conductive layers facing inside and in a 180 degree orientation with respect to rubbing directions of the alignment layers. Preparation of the alignment layers may be by other methods, such a printing of the alignment layers on the substrate(s), or other suitable techniques.

Examples of transparent substrates 14 and 16 include polymer films. The polymer films include films made of polyolefin, polyester, spolyacrylate, polycarbonate, polyether sulfones, and other suitable materials known to a person of ordinary skill and/or combinations thereof. In one example, the flexible films comprise PET films. The transparent substrates may also include glass and rigid polymeric materials.

Electrical leads are attached to the conductive layers via a voltage source connected to the conductive layers, in order to switch the ULH CLC material layer 12 between different optical states by application of electric field pulses. The voltage source may be an AC voltage source at a desired frequency or a DC-AC inverter and a battery. In addition, the switching power may be supplied by a photovoltaic device that converts solar power to electrical power, or any other suitable power system.

In an example, the ULH CLC material 12 comprises nematic liquid crystals (NLC) and a chiral dopant. In an example, the cholesteric liquid crystal mixture was prepared by adding 1-3 wt % of a high helical twisting power (HTP) chiral dopant, such as BDH-1281 or R-5011 (Merck) into a NLC host mixture. Constituents of the NLC host mixture may be a commercial NLC MLC-2048 (Merck) with small flexoelectric coefficient and a bimesogenic nematic liquid crystal dopant with a large flexoelectric coefficient. In an alternate particular example, the NLC may be about 71.75 wt % of a MLC 6080: S-30° C. N 95° CI; Δn=0.202; ΔE=+7.2 from Merck. An amount of a reactive monomer, such as about 3 wt % of RM 257: RM 257: S 70° C. N 126° C. may be used. A chiral dopant, such as about 25 wt % of a CE1:CB15:R1011 may be provided in the mixture, along with a photoinitiator, such as in the amount of 0.25 wt % of a Irgacure 651. The chiral dopant is an optically active organic compound selected from the group consisting of CB15, CB7CB, BDH-1281, R-5011 C15, R811, 5811, R1011, 51011, and any combination thereof. Other suitable chiral dopants may also be used. The spacing between the substrates of the cell may be about 2 εm. In another particular example, the NLC may be about or 93.75 wt % of a dual frequency LC, such as a ZLI 2048 DF-NLC: Δε=+4^{˜-}−2′f_{c}^{˜-}16 KHz from Merck, or MLC-2048. An amount of a reactive monomer, such as about 3 wt % of RM 257: S-30° C. N 95° CI; Δn=0.202; ΔE=+7.2 may be used. A chiral dopant, such as about 6 wt % of a CE1:CB15:R-1011 or Iso-(60SB)2 may be provided in the mixture, along with a photoinitiator, such as in the amount of 0.25 wt % of a Irgacure 651. The spacing between the substrates of the cell may be about 2 μm. Other combinations of mesogenic materials may be used as would be apparent to a person of ordinary skill, being a combination of material with a small flexoelectric coefficient and large flexoelectric coefficient. Similarly, other suitable reactive monomers, photoinitiators and spacings may be used. In the first example above, both NLC materials have small positive dielectric anisotropy (such as Δε<+3.3). The amount of the chiral dopant was adjusted in order to have a desired CLC pitch, such as in the range of about 100-300 nm. The pitch was calculated from the location of the CLC selective reflection band obtained in a direct measurement of reflectance from the sample with a planar CLC texture. As also shown in FIG. 1, polarizers 18 and 20 may be provided for analysis of the optical characteristics as will be described. In this device 10, the active retardation film produced is based on a polymer-stabilized cholesteric liquid crystal (PS-CLC) in a cell with helix lying generally in the plane parallel to the substrates at zero voltage. The helical axis tilts in-plane from the initial alignment state in response to an applied electric field. The magnitude of tilt depends on applied voltage, frequency of applied voltage and waveform. The invention relates to the CLC mixture for flexoelectro-optic liquid crystal mode and methods to obtain fast and large angle flexoelectric in-plane rotation of the helical axis (HA) in the uniform lying helix (ULH) CLC texture, and a flexoelectro-optic LC device operating at room temperature. In this invention, the liquid crystal (LC) mixture for flexoelecro-optic LC mode is produced from constituents with smaller and bigger flexoelectric coefficients and different temperature ranges of LC phases. A uniform lying helix LC device with a large flexoelastic coefficient, fast flexoelectric switching and operating at a room temperature is produced. In the electro-optical cell 10 of this example, the alignment layers are treated to provide uniform alignment of the cholesteric helix. Polymerizing a small amount of a reactive monomer in the cholesteric stabilizes the ULH texture at zero voltage. The electro-optical effect is achieved by applying a bias field to induce an in-plane rotation of cholesteric helix initially generally parallel to one of a pair of polarizers 18 and 20 crossed at 90 degrees. The retardation value of PS-CLC reaches maximum in response to a bias electric voltage when the rotation of the helix axis is at a generally 45-degree tilt between the crossed polarizers. Other tilts are achievable, as a function of the magnitude of the applied voltage. The active retardation films can be used as single or tandem films, to provide flexibility in the amount of retardation provided or to achieve desired optical properties. These features provide for use in many device applications including beam steering devices, spatial light modulators, displays including 3D displays, LCD televisions or displays, and other optical devices.

In the examples above, the electro-optical effect is achieved by applying a bias electric field to induce an in-plane rotation of cholesteric helical axis which is initially generally parallel to one of a pair of polarizers crossed at 90 degrees. The retardation value of PS-CLC reaches maximum in response to a bias electric voltage when the rotation of the helix axis is at 45-degree tilt between the crossed polarizers. The active retardation films can be used as single or tandem films. These added features offer many new device applications including beam steering devices, spatial light modulators and a variety of displays or other electro-optical devices.

The CLC material may also include a polymer matrix formed from at least one chiral material, at least one polymerizable monomer and at least one photo-initiator. As will be described, the polymer matrix stabilizes or supports the uniformity lying helix (ULH) of the CLC texture. In the first example above, the ULH CLC texture was obtained in the electro-optic cells 10 with a homogeneous (planar) alignment and was stabilized by a UV light induced photo polymerization of a small amount of reactive monomer, such as RM-257 (Merck) with the photo initiator such as Ir-651 (Ciba). Cell gaps in the device 10 were precisely controlled with particle spacers and verified by an interference method to be in the range of 2.00-2.50 μm, but other suitable spacings may be used.

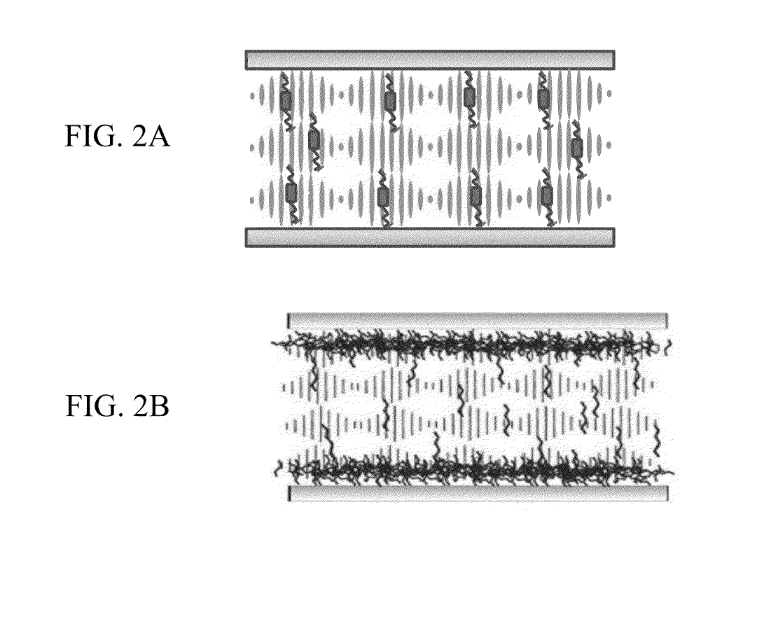

The polymer matrix has characteristics to facilitate maintaining stability of both the light transmitting and light scattering states in the device 10 and facilitating producing the large flexoelectric coefficient, fast flexoelectric switching and operation at room temperature without a field applied after switching between the states. As seen in FIGS. 2a and 2b, the CLC material prior to polymerization is shown in FIG. 2a, and polymerization of a small amount of a reactive monomer in the cholesteric is shown in FIG. 2b, which stabilizes the ULH texture at zero voltage.

The polymerization could be of an amount of reactive monomer in the range of 0.1-5%, or in the range of 0.5 to 3.5% or between 1 and 3% for example. The characteristics of polymerization of this amount of the reactive monomer relate to forming a polymer network adjacent the substrates 12 and 14, to localize the polymer fibers on the surfaces, which result in structures that minimize the light scattering and maximize the light transmission between the on state and off state. The purposes of the formed polymer fibers include to stabilize this UHL line in the plane generally parallel to the substrates at zero voltage. The localization of the polymer fibers on the surfaces of the substrates also enhances the UHL memory effect so as to enhance the helix anchoring strengths, such that the response time between on and off states is significantly faster. The cell gap in which the CLC material is disposed in the device 10, facilitates the function of the surface localized polymer fibers to provide these characteristics. The polymer matrix is generally formed by polymerization or crosslinking of at least one polymerizable monomer or crosslinkable polymer with non-reactive nematic liquid crystals, and a chiral additive. Polymerization of the liquid crystal mixture is initialized in any suitable manner, as by UV radiation, thermally, etc., depending upon the polymer used. The cholesteric liquid crystal material may include at least about 90.0% by weight nematic liquid crystal material, at least about 3.0% by weight of high twisting power (HTP) chiral dopant material and at least about 0.5% by weight photo-initiator.

The process for making the electro-optical device may include the steps of (a) providing two transparent substrates, with one or both coated with a transparent conductive layer, wherein the substrates are separated by spacers to create an area between the substrates (b) depositing a cholesteric liquid crystal (CLC) mixture and an amount of chiral dopant and containing a polymerizable material in the area between the substrates, and (c) polymerizing an amount of polymerizable material to provide the ULH texture in the CLC material, with the helical axis (HA) substantially parallel to the plane of the substrates. In an example, the transparent substrates are coated with ITO and heated to remove moisture. The ITO coated-surface of one of the substrates is then separated from the other ITO coated-surface with spacers. The liquid crystal-monomer mixture is then deposited onto at least one of the substrates. The second transparent substrate provided in spaced relation with the first substrate so that the liquid crystal-monomer mixture contacts the conductive layers on each of transparent substrates. In another example, spacers are included in the CLC mixture and are applied to the transparent substrate when the CLC material is coat deposited or coated onto the substrate. The CLC material can be coated onto the conductive film by any known method suitable for coating liquid materials. For example, the CLC material may be applied to the conductive film by gravure coating, curtain coating, die-coating, printing, screen printing or other suitable system. A seen in FIG. 3, the sample preparation may include preparation of a 2 μm, planar alignment LC cell into which the described CLC mixture is introduced at 30, with the substrates coated with alignment layers whereby the alignment layers are treated to provide uniform alignment of the cholesteric helix. An applied voltage is increased to result in a vertical standing helix at room temperature at 32. The applied voltage is maintained to result in the uniform layer helix texture at 34 and polymerization of a small amount of the polymerizable material is performed at 36 to stabilize the ULH texture at room temperature. The alignment layers provide this stabilization in conjunction with the surface localized polymer fibers to provide these characteristics. The alignment layers may be made by suitable techniques, such as application of unidirectional shear under an applied AC electric field, photo alignment, non-contact alignment, use of e-beam lithography to provide nano-grooves, or other suitable alignment techniques for enhancing ULH alignment with the helix axis substantially parallel to the wave vector of the surface grooves. For example, e-beam lithography may effectively provide nano-grooves for ULH alignment with the helix axis generally parallel to the wave vector of the surface stripes produced. Such techniques may include forming nano-grooves by other suitable techniques, such as ink-jet printing or other suitable techniques.

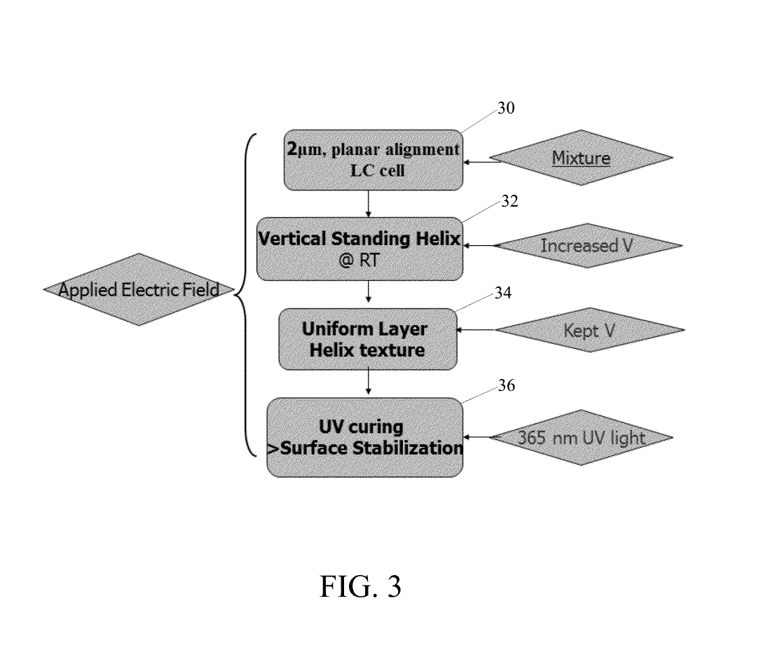

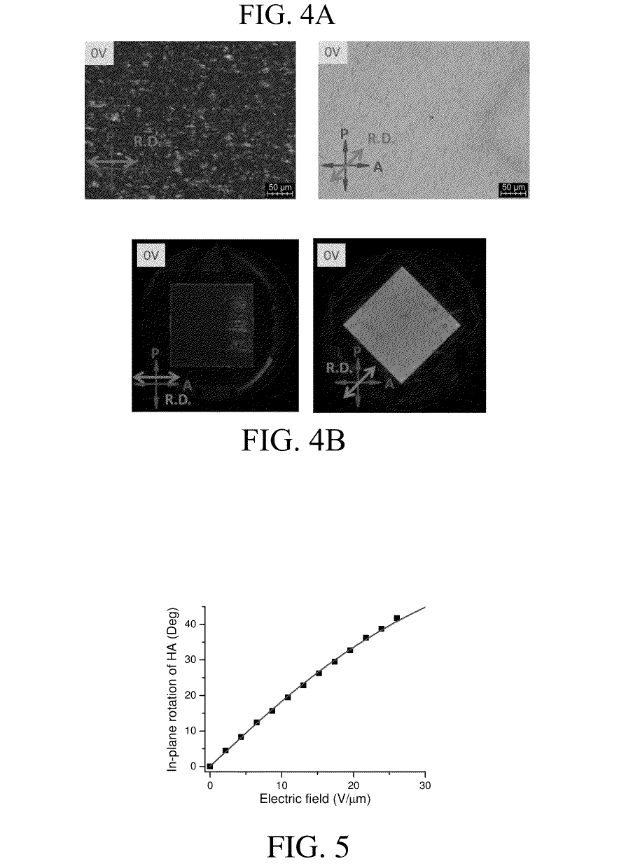

The appearance of the ULH texture in processed samples of the device of the invention under polarizing optical microscope (POM) and between crossed polarizers is shown in FIG. 4a and on a light table in FIG. 4b.

The described invention provides a uniform lying helix LC device with a large flexoelastic coefficient, fast flexoelectric switching and operating at a room temperature. The characterization of the flexeoelectric response of the CLC mixture may be evaluated by measurement of the in-plane rotation of the HA as a function of applied electric field. The data of the electric field inducing in-plane rotation of the HA is shown in FIG. 5. The measurement was performed by driving the sample with a 60 Hz AC electric field and a square waveform. Other suitable electric fields, frequencies and/or waveforms may be used.

The effective flexoelectric coefficient (e/K) of the CLC mixture may be calculated from fitting of experimental data using equation (1) above, which in this example is 0.88 C/N/m at p=238 nm. An in-plane rotation of the HA for 22.5 degrees was observed at 29.3V (12.7V/μm) applied across the cell gap. The maximum measured in-plane rotation of the HA was 41.8 degrees at 60V (26.1V/μm). From continued fitting curve, the rotation of the HA for 45 degrees is expected to occur at about 69V (30V/μm).

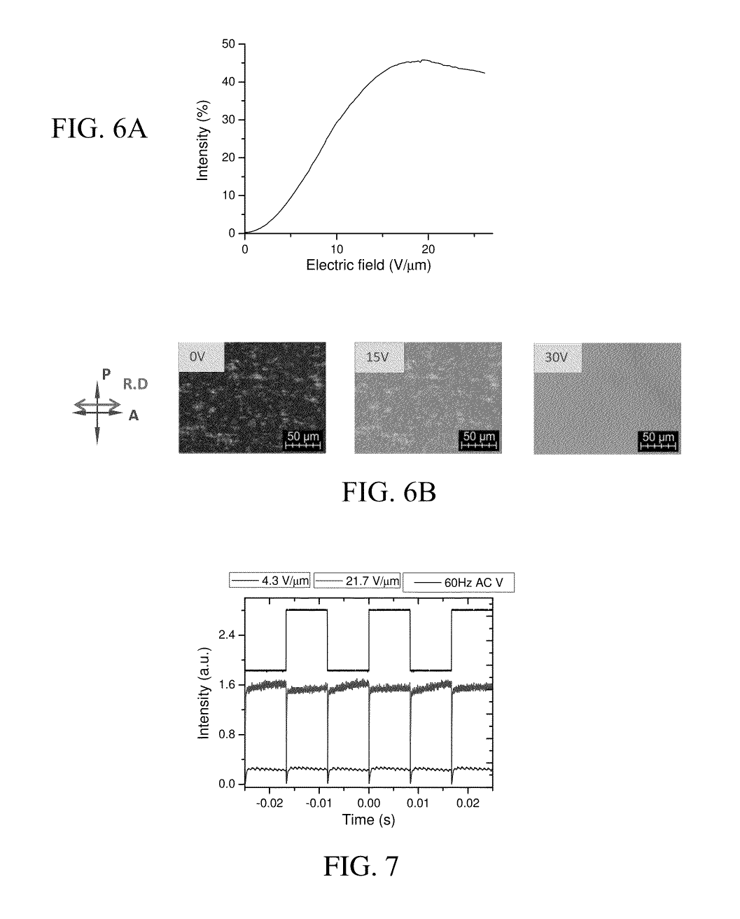

Characterization of the electro-optic performance of the example cell samples may be performed by measuring the transmittance as a function of applied voltage (TV curve), the response time and contrast ratio. FIGS. 6a and 6b, where FIG. 6a shows the TV curve with the flexoelectro-optic response of the samples with the HA parallel to the polarizer in the initial (0V) state. Data shown on FIG. 6a is normalized to the maximum retardation of the sample at 0V state. In the normally dark state the transmittance is expected to raise as a function of applied electric filed proportionally to the in-plane rotation of the HA and to reach its maximum at the electric field corresponding to the in-plane rotation of the HA for 45 degrees. The maximum of transmittance on FIG. 6 is at 19.7 V/μm corresponding to a rotation of the HA for ˜33 degrees. The discrepancy is due to an increased contribution to the transmittance from the dielectric coupling to an applied electric field. After 45V (19.7V/μm) the decrease in transmittance due to a decrease in effective Δn(E) overcomes an increase in the transmittance from the φ(E) and as result an effective transmittance through the sample is decreasing. FIG. 6b shows POM images with corresponding magnitude of applied voltage of the sample.

The maximum contrast ratio (CR) in the experimental samples was ˜150:1. In this example, the CR was limited by noticeable amount of undesired light leakage in the dark state at 0V caused by nonuniformities in the ULH texture and at the same time the maximum voltage induced retardation in the bright state being smaller than needed for a half wave retardation. The CR can be improved by obtaining the ULH texture with a better uniformity in alignment and increasing the retardation value of the ULH CLC layer.

In the sample, the experimental evidence of the flexoelectro-optic effect is the sensitivity of the electro-optic response of the sample to the polarity of applied electric field. The waveforms of driving AC voltage and flexoelectro-optic response of the sample in the normally dark configuration are shown in FIG. 7. In FIG. 7, the graph shows results at 4.3V/∞m at 40, 21.7V/μm at 42 and 60V/μm at 44. When the polarity of the applied electric field is reversed the HA rotates in the plane of the cell to an opposite orientation corresponding to short periodic changes of the transmittance through the sample.

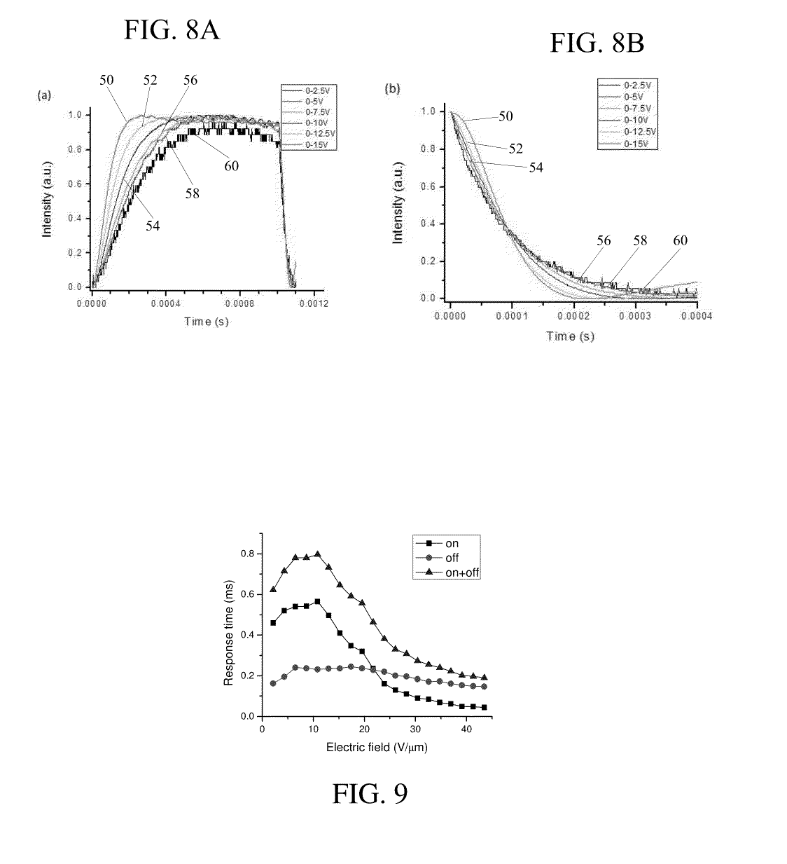

A flexoelectric response time in the samples according to the invention is inversely proportional to the magnitude of applied electric field, as show in FIGS. 8a and 8b. FIG. 8a shows the rise times and FIG. 8b shows decay times as function of applied voltages. With surface localized polymer fibers, the cholesteric helices are not only stabilized at zero voltage but also exhibit increased surface anchoring strength of alignment at zero voltage. As shown in FIG. 8a, the response (rise) time is voltage dependent due to the field-induced in-plane tilt angle. By contrast, the decay time is a relaxation process which is less dependent on initial applied bias voltage. In FIGS. 8a and 8b, the curves shown are for 0-15V at 50, 0-12.5V at 52, 0-10V at 54, 0-7.5V at 56, 0-5V at 58 and 0-2.5V at 60.

To better illustrate the flexoelectric response of a representative PS-CLC sample, the turn-on, turn-off and total response times are plotted in FIG. 9. The turn-on time is about 550 μs at 10 V/μm and the turn-off time is about 250 μs. The total response time is more than one order magnitude faster than that of a conventional nematic liquid crystal device.

The response time shown in FIG. 8 was measured for switching between 0V and Von states and was calculated between the points of 10% from the minimum and 90% from the maximum of the transmitted light intensity through the sample. It is noted that the device achieved about an order of magnitude difference in the response time between high and low voltages. However, due to a smaller operation range of voltage in LC devices the difference in response time will be smaller and can be ignored.

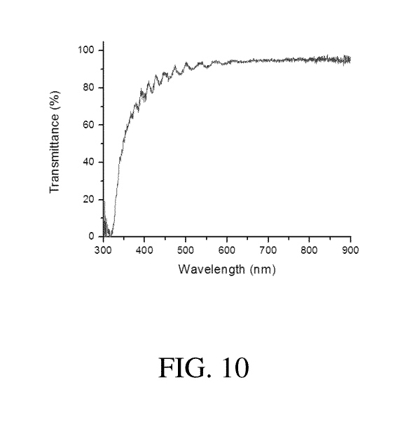

FIG. 10 shows the transmission spectrum of a PS-CLC active retarder according to an example of the invention as a function of wavelength. In general, as seen in the spectrum, the transmittance of the PS-CLC active retarder is slightly low in the short blue wavelength (480 nm=88.5%) transmittance, but is very high transmittance in the green (540 nm=92.4%) and red (640 nm=94.2%) wavelength regions. The short wavelength absorption may be further improved via the formation of a shorter-pitched CLC material, for example CLC material having a pitch of 400 nanometers or less.

The invention demonstrates an approach to design the CLC mixture for flexoelectro-optic LC mode with desired flexoelastic properties by using liquid crystal constituents with small and large flexoelectric coefficients. The method provides an ability to control the temperature range of the LC phase of CLC mixture without a significant increase in effective viscosity which slows down the flexoelectric response time. The invention achieves an in-plane rotation of the HA needed for full light intensity modulation with electric field of 12.7 V/μm applied across the cell and a flexoelectric response time of 0.2-0.8 ms. The operating voltage of the samples can be further lowered by increasing the concentration of a room temperature mixture of bimesogenic LC component of the CLC mixture up to one hundred percent. The use of a small amount of chiral dopant with high twisting power provides an ability to control the temperature range of the LC phase of CLC mixture without a significant increase in effective viscosity, which slows down the flexoelectric response time. The use of a chiral dopant that exhibits high twisting power that is independent of temperature. The invention also provides a flexoelectro-optic ULH CLC device operating at room temperature with a high contrast ratio. The contrast ratio can be further improved with a better dark state alignment provided by the alignment layers.

The invention provides an approach to design the CLC mixture for flexoelectro-optic LC mode with desired flexoelectric properties by using liquid crystal constituents with small and large flexoelectric coefficients. The invention and method provides an ability to control the temperature range of the LC phase of CLC mixture without a significant increase in effective viscosity which slows down the flexoelectric response time. The invention achieves an in-plane rotation of the HA needed for full light intensity modulation with electric field of 12.7 V/μm applied across the cell according to the example, and a flexoelectric response time of 0.2-0.8 ms.

The active retardation device of the invention may be used to modulate one or more of the optical properties (amplitude, phase or polarization) of an optical wavefront that may be either electrical, optical or pressure sensitive is useful for a wide range of applications including smart windows, switchable gratings, beam steering devices, spatial light modulators, light extracting devices, touch sensors, detectors, displays (with motion picture quality images) and other electro-optical devices.

Based upon the foregoing disclosure, it should now be apparent that the electro-optical device and active retarders based on PS-CLC materials as described herein will carry out the objects set forth hereinabove. It is, therefore, to be understood that any variations evident fall within the scope of the claimed invention and thus, the selection of specific component elements can be determined without departing from the spirit of the invention herein disclosed and described.

What is claimed is:

1. A liquid crystal device comprising:
a first transparent substrate having an interior and exterior surface;
a second transparent substrate having an interior and exterior surface, wherein the first and second substrates are separated by a predetermined distance;
an electrically conductive layer located on the interior surface of each of the first and second substrates;
at least one alignment layer formed on the interior surface of at least one of the substrates;
a liquid crystal material comprising at least one nematic liquid crystal material having a small flexoelectric coefficient and a bimesogenic nematic liquid crystal dopant with a large flexoelectric coefficient; and
a polymer matrix comprising at least one chiral material, at least one polymerizable monomer and a photo-initiator, wherein the liquid crystal material is contained within and between the electrically conductive layers of the first and second transparent substrates, and wherein the liquid crystal material forms a uniform lying helix (ULH) texture with no voltage applied and at room temperature, and is switchable by the application of an electric field.

2. The liquid crystal device of claim 1, wherein the liquid crystal material is a cholesteric liquid crystal (CLC) material.

3. The liquid crystal device of claim 2, wherein the amount of the at least one chiral is selected to provide a desired CLC pitch.

4. The liquid crystal device of claim 3, wherein the CLC pitch is in the range of about 100-300 nm.

5. The liquid crystal device of claim 1, wherein the device is an active retardation film produced with a polymer-stabilized cholesteric liquid crystal (PS-CLC) in a cell with the cholesteric helix of the PS-CLC lying generally in the plane generally parallel to the substrates at zero voltage.

6. The liquid crystal device of claim 5, wherein the helical axis of the PS-CLC tilts in-plane from the initial alignment state in response to an applied electric field.

7. The liquid crystal device of claim 6, wherein the magnitude of tilt depends on applied voltage, frequency of applied voltage and waveform of the applied voltage.

8. The liquid crystal device of claim 5, wherein the retardation value of PS-CLC reaches maximum in response to a bias electric voltage when the rotation of the helix axis is at a generally 45-degree tilt.

9. The liquid crystal device of claim 2, wherein the CLC mixture obtains fast and large angle flexoelectric in-plane rotation of the helical axis (HA) of the CLC material in the uniform lying helix (ULH) CLC texture, and operates at room temperature.

10. The liquid crystal device of claim 2, wherein the alignment layers are treated to provide uniform alignment of the cholesteric helix.

11. The liquid crystal device of claim 2, wherein polymerizing an amount of a reactive monomer in the CLC stabilizes the ULH texture at zero voltage.

12. The liquid crystal device of claim 5, wherein the active retardation film can be used as single or tandem films, to provide a desired amount of retardation.

13. The liquid crystal device of claim 5, wherein the retardation value of PS-CLC reaches maximum in response to a bias electric voltage when the rotation of the helix axis is at a generally 45-degree tilt.

14. The liquid crystal device of claim 1, wherein the substrates are flexible.

15. The liquid crystal device of claim 2, wherein the alignment layer has nano-sized grooves to align the helix axis (HA) of the CLC material.

16. The electro-optical device according to claim 7, wherein the chiral material is an optically active organic compound having a high helical twisting power (HTP).

17. A method of preparing a liquid crystal device, the method comprising the steps of:
providing a mixture comprising at least one liquid crystal material including at least one nematic liquid crystal material having a small flexoelectric coefficient and a bimesogenic nematic liquid crystal dopant with a large flexoelectric coefficient, at least one chiral dopant, at least one polymerizable monomer, and a photo-initiator;
dissolving the mixture in a solvent to form a solution;
introducing the solution into a cell comprising a first and second transparent substrates, wherein each of the substrates has an interior and exterior surface and an electrically conductive layer is located on the interior surface of each of the first and second substrates; and
curing the mixture in the presence of an external electric field, wherein application of the electric field aligns the at least one liquid crystal material of the mixture in a uniform lying helix (ULH) texture with no voltage applied and at room temperature, and is switchable by the application of an electric field.

18. The method of claim 17, wherein the device includes a cell wherein the liquid crystal material is a polymer-stabilized cholesteric liquid crystal (PS-CLC), formed by a polymer network formed from photo-polymerization of at least one reactive monomer, and wherein the retardation value of PS-CLC reaches maximum in response to a bias electric voltage when the rotation of the helix axis is at a generally 45-degree tilt.

19. The method of claim 18, wherein the device is an active retardation film produced with the cholesteric helix of the PS-CLC lying generally in the plane generally parallel to the substrates at zero voltage.

20. The method of claim 18, further comprising forming an alignment layer on each substrate which have nano-sized grooves to align the helix axis (HA) of the CLC material.
